(19) United States
(12) Patent Application Publication
(10) Pub. No.: US 2009/0068443 A1
(43) Pub. Date: Mar. 12, 2009

(54) HIGHLY CHEMICAL-RESISTANT GLOVE

(76) Inventors: Jean Curtet, Bouffemont (FR); Olivier Pillard, Blocourt (FR); Christine David, Jonquieres (FR); Sandrine Pinchon, Nointel (FR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/161,973

(22) PCT Filed: Jan. 29, 2007
(86) PCT No.: PCT/FR07/00163

§ 371 Date: Sep. 29, 2008

(30) Foreign Application Priority Data
Feb. 2, 2006 (FR) 06 00947

(51) Int. Cl. A41D 31/02; B32B 15/14; B29C 41/02; A41D 13/00; A41D 3/08; A41D 3/02; A41D 1/06; A43B 3/16; A41D 19/015

(52) U.S. Cl. 428/332; 428/500; 428/421; 428/494; 428/335; 427/133; 428/339; 2/456; 2/84; 2/85; 2/227; 36/7.1 R; 2/161.6

(57) ABSTRACT

The invention concerns an article for protecting the user from risks associated with the handling of chemicals, and comprising: (i) at least one inner layer of a material selected among natural and synthetic latexes; (ii) at least one partly hydrolyzed polyvinyl alcohol (PVA) layer, having an hydrolysis rate ranging between 70 and 95%; (iii) at least one self-crosslinking synthetic latex layer.

One subject of the present invention is a protective article intended to protect the user from the risks associated with handling chemicals.

In order to protect users when handling dangerous chemicals, multilayer materials which comprise at least one layer of a material that is impermeable to said chemicals, that is to say a barrier material, are normally used. The effectiveness of the barrier effect of a material is determined by its resistance to permeation, which is measured by the time taken for a given chemical to pass through the material. The materials used for manufacturing individual protective equipment must moreover have sufficient mechanical strength and puncture resistance for everyday use, in a laboratory or a workshop for example.

Moreover, in order to allow the user to handle various objects and tools, a piece of protective clothing such as a glove which has a three-dimensional structure, which is free of outer welds or seams and which is flexible so as to be able to match the movements of the user is preferred. Finally, it is also expected that such a glove is water resistant.

Generally, a barrier material ensures protection against a limited number of chemicals. When a user must handle several products belonging to different chemical families, a common solution consists in superposing gloves that are resistant to each of these families in order to form a complementary protection. This solution, leading to a not very ergonomic superposition, has the drawback of hindering handling.

Known from document WO 02/080713, is a protective glove intended to protect against chemicals, this glove being formed from a layer of rubber latex and from a layer of polyvinyl alcohol.

According to this document, the inner layer, which is in contact with the skin of the user, is formed from polyvinyl alcohol whereas the outer layer is formed from rubber. The outer rubber layer, which is water-resistant, is very easily degraded in contact with certain organic solvents. Consequently, these gloves are not suitable for handling these chemicals.

Also known are protective articles having a multilayer structure based on polyolefin and on EVOH: U.S. Pat. No. 5,491,022, U.S. Pat. No. 5,059,477, U.S. Pat. No. 4,855,178 and U.S. Pat. No. 5,162,148. These protective articles have the drawback of offering a low level of chemical protection towards amines (methylamine, ethylamine, etc.) and of having low mechanical and thermal protection and also low elasticity. On the other hand, these materials, when they are assembled in order to manufacture a glove, have overthicknesses at the welds compared to the remainder of the material, which is not the case for articles obtained by dip-coating.

Chemical protection has two complementary aspects:
on the one hand, for a certain number of chemicals, the time for which a barrier material withstands permeation by each of these chemicals taken individually is evaluated; and
on the other hand, for a desired period of resistance, the number of families of different chemicals to which such a material forms a barrier is considered.

The objective of the invention was to provide a material that forms a barrier to the greatest possible number of chemicals for as long a period as possible. It was also sought to develop a water-resistant glove.

Compared to the articles from the prior art, it was sought to improve the time for which the material formed a barrier to the chemicals and to expand the range of families of chemicals which are stopped by this material. Moreover, it was sought to obtain an article, especially a glove, that is water-resistant and has a satisfactory flexibility. Such a result was obtained in accordance with the present invention owing to the superposition of a layer of natural or synthetic latex, a layer of partially hydrolyzed polyvinyl alcohol, a layer of a synthetic latex and optionally a finishing layer based on silica and on a dispersion of a cationic fluoropolymer.

Document U.S. Pat. No. 5,438,709 describes an elastomeric glove covered with a layer of polyvinyl alcohol and of a thickening agent. The polyvinyl alcohol used is of a completely hydrolyzed quality. The gloves described in this document are more particularly intended to be used as a base to form an orthopedic bandage, due to their lubricious nature in the presence of water.

Document JP 56-078930 describes a fabric glove which is dip-coated into a solution of polyvinyl alcohol then dried and dip-coated into a dispersion of a polyvinyl chloride (PVC) resin, before being demolded. This process gives a fabric glove which has a pleasant feel and is flexible.

One subject of the invention is a protective article, preferably a glove, offering improved protection against the penetration of chemicals, this article comprising:
(i) at least an inner layer of a material chosen from natural and synthetic latices;
(ii) at least one layer of a partially hydrolyzed polyvinyl alcohol (PVA), having a degree of hydrolysis between 70 and 95%; and
(iii) at least one layer of a self-crosslinking synthetic latex.

According to one advantageous variant of the invention, the protective article additionally comprises:
(iv) at least one layer of a mixture of silica and of a cationic fluorinated resin.

Compared to the barrier materials of the prior art, and as will be demonstrated in the experimental section, the materials of the invention make it possible to increase the time taken for the solvents to pass through said material and to constitute a barrier towards an expanded range of chemicals. Moreover, this material and the articles obtained from this material have a remarkable elasticity compared to the multilayer materials of the prior art and are water-resistant.

In greater detail, the articles of the invention preferably comprise a support layer composed of a textile. This may be a woven fabric or a knit fabric, based on a natural fiber such as cotton, wool, linen, viscose, or on a synthetic fiber such as polyester, polyamide, polyethylene, in particular high-modulus and high-tenacity polyethylene, aramid or para-aramid, or a mixture of several types of fibers.

Preferably, the textile support is made of cotton.

The textile support layer, which is in contact with the skin of the user, is intended both to promote the mechanical strength of the article of the invention and to offer a pleasant feel to the user over a long use.

The latex layer (i) is chosen for its barrier properties to chemicals. It is chosen from natural latices and synthetic latices.

A layer of natural latex has the advantage of conferring a greater flexibility to the protective articles and, at equal thickness, of being less expensive than a layer of synthetic latex.

According to whether or not a textile support is used, the latex layer may constitute the first or the second thickness of the protective article starting from the skin of the user and going towards the outer face of the protective article.

When the latex layer (i) is chosen from synthetic latices, it may be made from a polychloroprene latex, but also from a nitrile or butyl rubber, a polyvinyl chloride, a fluoroelastomer, a polyurethane, a chlorosulfonated polyethylene, a chlorinated polyethylene, an ethylene acrylate, a polyacrylate or a combination of these materials.

According to one variant, it may be anticipated to use a layer of natural latex onto which a layer of synthetic latex is superposed.

According to whether the protective article is constructed from a textile support and/or a layer of natural latex or whether it is chosen, on the other hand, to use the smallest number of different materials, the synthetic latex may form the support layer or the second or third layer of the protective article of the invention.

Advantageously, the last layer of latex is covered with an adhesive layer intended to promote better adhesion of the polyvinyl alcohol layer to the latex.

This intermediate adhesive layer may be composed of any material known to a person skilled in the art and that is capable of fulfilling this role.

It may especially be a blend of latex, identical to that used in (i) and of PVA used in (ii). Preferably, a blend of an acrylic latex and of the PVA used in (ii) is chosen. The adhesive layer improves the mechanical strength of the protective article, in particular its peel strength, and contributes to the flexibility of the article.

According to one variant of the invention, the application of the adhesive layer may be replaced by the application of a polyvinyl alcohol coagulant.

A layer (ii) of polyvinyl alcohol (PVA) is then provided, either directly on the latex, or on the intermediate adhesive layer, or on the PVA coagulant. This layer (ii) is made up of partially hydrolyzed polyvinyl alcohol having a degree of hydrolysis between 70 and 95%, preferably between 85 and 90%.

The layer (iii) of synthetic latex may be made up of any synthetic latex as already described above for the layer (i). Preferably, the layer (iii) of synthetic latex is chosen from acrylic latices, styrene-butadiene latices and nitrile latices of self-crosslinking nature.

Preferably, the layer (iii) of synthetic latex also comprises polyvinyl alcohol.

The polyvinyl alcohol used in the layer (iii) has any degree of hydrolysis. Preferably, it has a degree of hydrolysis between 70 and 95%. Advantageously, the polyvinyl alcohol from the layer (iii) is the same as that from the layer (ii).

The proportion of latex and of polyvinyl alcohol in the blend of the layer (iii) is between 3 and 10%, preferably 4 to 8% of polyvinyl alcohol, by weight of active material relative to the weight of synthetic latex.

When it is present, the outer layer (iv) is advantageously made up of a mixture of silica in aqueous dispersion and of a cationic fluorinated resin. Preferably, the silica is a precipitated silica or a fumed silica. Preferably, the silica is a fumed silica of colloidal nature.

The successive layers (i) to (iii) described above form the minimum structure of the protective articles of the invention. As has already been explained, optional layers may be provided at the locations indicated, but other variants are possible around this base structure. Moreover, certain layers may be present in several thicknesses.

For example, the latex of the layer (i) or the PVA of the layer (ii), the latex of the layer (iii) and optionally the mixture of the layer (iv) may be applied repeatedly with an intermediate drying step between two applications.

Preferably, the protective article of the invention has a thickness of layer (i) of natural or synthetic latex ranging from 100 to 400 μm.

Preferably, the protective article of the invention has a polyvinyl alcohol layer (ii) of thickness between 30 and 200 μm.

Advantageously, the protective article of the invention has a thickness of layer (ii) of PVA, having a degree of hydrolysis ranging from 70 to 95%, of 60 to 150 μm and a thickness of synthetic latex layer (iii) ranging from 10 to 20 μm.

Preferably, the protective article of the invention has a layer (iv) of a mixture of silica and of fluorinated resin having a thickness ranging from 1 to 5 μm.

Preferably, the thickness of the adhesive layer is between 5 and 50 μm.

Surprisingly, the resistance of the protective articles of the invention to penetration by solvents is greater than the sum of the resistances of each of the constituent materials of these articles. Polychloroprene and partially hydrolyzed PVAs are known for their resistance to permeation by chemicals. However, there was nothing in the prior art to suggest that the materials of the invention, when they are present in one and the same protective article and in the order indicated above, make it possible to obtain a protection much greater than the sum of the protection conferred by each of the materials taken individually. Moreover, the protective articles of the invention have a good water resistance and have a satisfactory flexibility.

Another subject of the invention is the process for producing a protective article intended to protect the handler from the risks associated with the use of chemicals.

Such a process comprises the following steps:
a) optionally, covering a mold with a layer of fabric;
b) optionally dipping the mold or the mold/fabric assembly from step a) into a coagulating solution;
c) dipping the mold or the mold/fabric assembly from step a) or from step b) into one or more aqueous dispersions of natural or synthetic latex (i);
d) optionally dipping the coated mold from step c) into water to enable the removal of the coagulating solution;
e) drying and optionally vulcanizing the coated mold from step c) or step d);
f) optionally dipping the coated mold obtained at the end of step c), d) or e) into one or more adhesive layers;
g) dipping the coated mold obtained at the end of step c) or step d) or e) or f) into one or more aqueous solutions of partially hydrolyzed PVA having a degree of hydrolysis between 70 and 95%;
h) dipping the coated mold obtained at the end of step g) into one or more aqueous dispersions of self-crosslinking synthetic latex, preferably chosen from acrylic latices, styrene-butadiene latices or nitrile latices;
i) not compulsorily, but preferably dipping the coated mold obtained at the end of step h) into one or more aqueous dispersions of a cationic fluorinated resin comprising silica;
and in a final step:
j) removing the glove by sliding over the mold.

The textile support, or the mold, is coated with natural or synthetic latex by a dip-coating operation known to a person skilled in the art. Each dip-coating step is optionally followed by a drying step and by a step of vulcanization or gelling in an oven.

When the coating comprises a layer of a natural latex, the invention anticipates dipping the optionally coated mold into a solution that allows the coagulation of the latex, then a drying step, then optionally dipping in one or more baths of a synthetic elastomer, each dip-coating step being followed by a drying step until the complete coagulation of the elastomer, then rinsing in water or in any solvent that enables the coagulant solution to be removed.

In a known manner, each dipping step from f) to i) is followed by a drying step having a duration of 5 minutes to around 1 hour, at a temperature of 30 to 90° C.

In a manner known to a person skilled in the art, it is anticipated at the end of step h) or step i) to dry the article then to vulcanize it before removing it from the mold.

Although the dipping technique is particularly suitable for manufacturing protective equipment such as gloves, overshoes, and more generally, any articles having a three-dimensional structure, it may also be anticipated, according to one variant of the invention, to manufacture a protective article according to the invention using other technologies known to a person skilled in the art such as coating, as long as the succession of the layers of materials described above is replicated in the order indicated.

Another subject of the invention are the protective articles described above and characterized in that they are in the form of a glove, an overshoe, coveralls, a hood, a cover, trousers or a jacket.

Since the aqueous polyvinyl alcohol solutions are generally very dilute, preferably several successive dipping operations are carried out in step g).

### EXAMPLE

1. Manufacture of a Glove:
a- A former was covered using a cotton textile.
b- The covered former was dipped in a coagulant solution for 10 seconds.
c- The covered former was dipped in a bath of natural latex for 120 seconds.
d- The former was then dipped in a bath of polychloroprene latex for 20 seconds. This operation was repeated so as to form a second layer of polychloroprene latex.
e- The former was then dipped in water to allow the removal of the coagulant solution.
f- After drying and vulcanizing of the preceding layers, the former was dipped, for 5 seconds, in a bath made up of:
   88 wt % of acrylic latex (CRAYMUL sold by Cray Valley);
   4 wt % of TiO₂; and
   8 wt % of PVA (MOWIOL 18-88 sold by SEPPIC).
   The percentages are given by weight of solid matter in the composition. The composition was in the form of an aqueous dispersion containing 30% of solids.
g- After drying for 15 minutes at 75° C., the former was dipped, for 5 seconds, in a bath made up of:
   60% of PVA (MOWIOL 18-88 sold by SEPPIC);
   30% of glycerol; and
   10% of silica (AEROSIL A200 sold by Brenntag).
   The percentages are given by weight of solid matter in the composition. The composition was in the form of an aqueous dispersion containing 12% of solids.

The operation g- was repeated a second time.
h- After drying for 30 minutes at 75° C., the former was dipped, for 5 seconds, in a bath made up of:
   90 wt % of acrylic latex (CRAYMUL);
   1.5 wt % of TiO₂;
   7 wt % of PVA (MOWIOL 20-98 sold by SEPPIC); and
   1.5 wt % of an acid catalyst (diammonium chloride).

The percentages are given by weight of solid matter in the composition. The composition was in the form of an aqueous dispersion containing 28% of solids.
i- After drying for 30 minutes at 85° C., the former was dipped, for 2 seconds, in a bath made up of:
   71 wt % of water;
   20 wt % of colloidal silica (BINDZIL sold by Eka Chemicals); and
   9 wt % of an aqueous dispersion of a cationic fluoropolymer (OLEOPHOBOL sold by Ciba).

The percentages are given by weight of solid matter in the composition. The composition was in the form of an aqueous dispersion containing 18% of solids.

The glove was crosslinked by heating at 120° C. for 30 minutes and it was demolded.

The glove obtained had the following characteristics measured at the lower part of the palm:
thickness of the natural latex layer (c-): 300 μm
thickness of the polychloroprene layer (d-): 260 μm
thickness of the acrylic adhesive layer (f-): 10 μm
thickness of the PVA layer (g-) (degree of hydrolysis: 88%): 130 μm
thickness of the acrylic layer (h-): 20 μm
thickness of the finishing layer (i-) 2 μm.

2. Variant in the Manufacture of a Glove:

The procedure from example 1 was repeated, removing step (i-) and using, in step (h-), a dispersion made up of:
97 wt % of a styrene-butadiene latex (SYNTHOMER sold by Synthomer Ltd.)
1.5 wt % of TiO₂
1.5 wt % of acid catalyst (diammonium phosphate).

The percentages are given by weight of active material in the composition. The composition was in the form of an aqueous dispersion containing 40% of solids.

3. Variant in the Manufacture of a Glove:

The procedure from example 1 was repeated, removing step (i-) and using, in step (h-), a dispersion made up of:
97 wt % of a nitrile latex (PERBUNAN sold by Polymer Latex)
1.5 wt % of TiO₂
1.5 wt % of melanin resin (PROX sold by SYNTHRON).

The percentages are given by weight of active material in the composition. The composition was in the form of an aqueous dispersion containing 45% of solids.

4. Permeation by an Expanded Range of Solvents:

Another glove (C1) was prepared by way of comparison, by reproducing steps a, b, c, d and e from example 1 and by crosslinking the glove obtained for 3 hours at 130° C.

| | Example 1 | |
|---|---|---|
| | glove | C1 glove |
| Total thickness (mm) | 1.4 | 1.24 |
| PVA thickness (mm) | 0.136 | / |

Permeation tests according to the EN 374-3 standard were carried out comparatively on the glove from example 1 and on the C1 glove. The results are given in Table 1. They are expressed in the form of the transfer time for each solvent in minutes according to the EN 374-3 standard.

TABLE 1
Evaluation of the versatility of the protection

| | | | |
|---|---|---|---|
| | | Example 1 | |
| Products | State | glove | C1 glove |

| | | | | | |
|---|---|---|---|---|---|
| Acetone | liquid | 293 | min | 14 | min |
| Dichloromethane | liquid | >480 | min | 5 | min |
| Toluene | liquid | >480 | min | 10 | min |
| Ethyl acetate | liquid | >480 | min | 19 | min |
| n-heptane | liquid | >480 | min | 20 | min |
| Hexane | liquid | >480 | min | 20 | min |
| Tetrahydrofuran | liquid | >480 | min | <5 | min |
| Methanol | liquid | 138 | min | 26 | min |
| Diethylamine | liquid | 73 | min | <5 | min |
| 40% sodium | liquid | >480 | min | >480 | min |
| hydroxide | | | | | |
| 96% sulfuric | liquid | >480 | min | 72 | min |
| acid | | | | | |
| Acetonitrile | liquid | >480 | min | 47 | min |
| Carbon | liquid | >480 | min | <5 | min |
| disulfide | | | | | |
| Ammonia | gas | >480 | min | >480 | min |
| Chlorine | gas | >480 | min | >480 | min |
| Hydrogen | gas | >480 | min | >480 | min |
| chloride | | | | | |

5. Water Resistance:

### Procedure

Using a punch, three pellets having a diameter of 66 mm were cut out from the palm of three gloves.
The three dried pellets (DP) were weighed.
The pellets were then attached to each of the absorption cells, the outer face being placed towards the side containing the demineralized water.
The cell was filled with demineralized water.
The pellets were turned over and put in an oven at 23° C. for 10 minutes.
The cells were emptied and the pellets were removed therefrom.
The pellets were blotted with filter paper.
The various wet pellets (WP) were weighed.
The film was visualized after contact (observation).

### Expression of the Results

The swelling was calculated according to the equation:

$$S \% = \frac{WP - DP}{DP} \times 100$$

The average and the standard deviation of each series of tests were calculated.

The present method makes it possible to determine the swelling with water of the outside of a glove. The principle rests on the capacity of a film to swell when in contact with water.

The glove of the invention (example 1) had a weight swelling evaluated by its index variation, of 8.7 wt % at the end of 90 minutes, without visual degradation.

The high water-resistance of the glove of the invention can be illustrated by the test below.

Swelling in water then drying to equilibrium and permeation test according to the EN 374-3 standard using diethylamine.

Transfer time

| | |
|---|---|
| After 1 hour: | 61 minutes |
| After 2 hours: | 51 minutes |
| After 4 hours: | 47 minutes |

5. Mechanical Strength of the Glove from Example 1:

The multilayer glove from example 1 has peel strengths between the layers (ii) and (i) having a minimum value of 4.5 N/cm according to the ISO 36 standard. Furthermore, this glove has the following mechanical properties according to the EN 374-3 standard.
Abrasion: level 3
Cutting: level 1
Tearing: level 4
Perforation: level 1.

1. A protective article comprising:
(i) at least an inner layer of a material chosen from natural and synthetic latices;
(ii) at least one layer of a partially hydrolyzed polyvinyl alcohol (PVA), having a degree of hydrolysis between 70 and 95%; and
(iii) at least one layer of a self-crosslinking synthetic latex.

2. The article as claimed in claim 1, characterized in that it additionally comprises:
(iv) at least one layer of a mixture of silica and of a cationic fluorinated resin.

3. The article as claimed in claim 1, characterized in that it additionally comprises a support layer formed from a textile made of a natural or synthetic fiber.

4. The article as claimed in claim 3, characterized in that the support layer is made of cotton.

5. The article as claimed in claim 1, characterized in that it comprises a layer (i) based on a natural latex, which constitutes the first or second thickness of the protective article.

6. The article as claimed in claim 5, characterized in that the thickness of natural latex is between 100 and 400 μm.

7. The article as claimed in claim 1, characterized in that it comprises a layer (i) of synthetic latex chosen from a polychloroprene latex, a nitrile rubber, a butyl rubber, a polyvinyl chloride, a fluoroelastomer, a polyurethane, a chlorosulfonated polyethylene, a chlorinated polyethylene, an ethylene acrylate, a polyacrylate or a combination of these materials.

8. The article as claimed in claim 7, characterized in that the thickness of the layer (i) of synthetic latex is between 100 and 400 μm.

9. The article as claimed in claim 1, characterized in that the latex layer (i) is covered with an adhesive layer.

10. The article as claimed in claim 9, characterized in that the adhesive layer comprises a blend of an acrylic latex and a polyvinyl alcohol (ii).

11. The article as claimed in claim 9, characterized in that the thickness of the adhesive layer is between 5 and 50 μm.

12. The article as claimed in claim 1, characterized in that the layer (ii) of polyvinyl alcohol is made up of partially hydrolyzed polyvinyl alcohol having a degree of hydrolysis between 85 and 90%.

13. The article as claimed in claim 1, characterized in that the layer (iii) of synthetic latex is chosen from acrylic latices, styrene-butadiene latices and nitrile latices of self-crosslinking nature.

14. The article as claimed in claim 1, characterized in that the layer (iii) of synthetic latex comprises polyvinyl alcohol.

15. The article as claimed in claim 1, characterized in that it comprises a thickness of synthetic latex layer (iii) between 10 and 20 μm.

16. The article as claimed in claim 1, characterized in that it comprises a thickness of polyvinyl alcohol (ii), having a degree of hydrolysis ranging from 70 to 95%, of 60 to 150 μm.

17. The article as claimed in claim 2, characterized in that it comprises a layer (iv) of a mixture of silica and of a cationic fluorinated resin having a thickness between 1 and 5 μm.

18. The article as claimed in claim 1, characterized in that it is in the form of a glove, an overshoe, coveralls, a hood, a cover, trousers or a jacket.

19. The article as claimed in claim 1, characterized in that it withstands, for more than 30 minutes, permeation by each of the following solvents: acetone, dichloromethane, toluene, ethyl acetate, n-heptane, n-hexane, tetrahydrofuran, methanol, diethylamine, 40% sodium hydroxide, 96% sulfuric acid, acetonitrile, carbon disulfide, ammonia, chlorine and hydrogen chloride, under the test conditions of the EN374-3 standard.

20. The process for producing a protective article comprising the following steps:
a) optionally, covering a mold with a layer of fabric;
b) optionally dipping the mold or the mold/fabric assembly from step a) into a coagulating solution;
c) dipping the mold or the mold/fabric assembly from step a) or from step b) into one or more aqueous dispersions of natural or synthetic latex (i);
d) optionally dipping the coated mold from step c) into water to enable the removal of the coagulating solution;
e) drying and optionally vulcanizing the coated mold from step c) or step d);
f) optionally dipping the coated mold obtained at the end of step c), d) or e) into one or more adhesive layers;
g) dipping the coated mold obtained at the end of step c) or step d) or e) or f) into one or more aqueous solutions of partially or completely hydrolyzed PVA having a degree of hydrolysis between 70 and 95%;
h) dipping the coated mold obtained at the end of step g) into one or more aqueous dispersions of self-crosslinking synthetic latex;
i) optionally dipping the coated mold obtained at the end of step h) into one or more aqueous dispersions of cationic fluorinated resin comprising silica;
and in a final step:
j) removing the glove by sliding over the mold.

21. The process as claimed in claim 20, characterized in that each dipping step f) to i) is followed by a drying step.
